(19) United States
(12) Patent Application Publication
(10) Pub. No.: US 2016/0321057 A1
(43) Pub. Date: Nov. 3, 2016

(54) ELECTRONIC APPARATUS

(71) Applicant: KYOCERA DOCUMENT SOLUTIONS INC., Osaka (JP)

(72) Inventor: Takeshi HAMAKAWA, Osaka (JP)

(21) Appl. No.: 15/104,972

(22) PCT Filed: Dec. 22, 2014
(86) PCT No.: PCT/JP2014/083858

§ 371 Date: Jun. 15, 2016

(30) Foreign Application Priority Data
Dec. 27, 2013 (JP) 2013-271377

(51) Int. Cl. G06F 9/445

(52) U.S. Cl. CPC G06F 8/65

(57) ABSTRACT

A processor 2 (a) downloads a update program used for update of a program 12; (b) copies a rewriting program 21 included in the program 12 into the non volatile memory 1 in accordance with the program 12; (c) after copying the rewriting program 21, changes a program started by a boot program 11 from the program 12 to the copied rewriting program, and reboots; (d) after the reboot, in accordance with the boot program 11, starts execution of the copied rewriting program; and (e) in accordance with the copied rewriting program, rewrites the program 12 in the non volatile memory 1 using the update program.

### TECHNICAL FIELD

The present invention relates to an electronic apparatus.

### BACKGROUND ART

A program to operate an embedded system such as a copier is stored in a non volatile memory in which the program is not deleted when powered off, and the program is rewritable by version upgrade.

A version upgrade method downloads an update program from a server on a network to a copier, rewrites a non volatile memory inside of the copier with the update program and then reboots, and thereby performs version upgrade under remote control.

However, for example, while rewriting the non volatile memory for version upgrade under remote control, a user who is not aware of such situation improperly performs a power-off operation or power off occurs due to power outage, and thereby the version upgrade may be incompletely terminated and the device may fall into an inoperative state. Therefore proposed is a method that migrates a program before version upgrade to another area, and enables to be operative in accordance with the program before version upgrade if power off occurs in the middle of the version upgrade (for example, see PATENT LITERATURE #1).

### CITATION LIST

### Patent Literature

PATENT LITERATURE #1: Japanese Patent Application Publication No. H11-265282.

### SUMMARY OF INVENTION

### Technical Problem

However, in the aforementioned method, when updating a large size of a program, a large size of a non volatile memory is required because it is necessary to allocate another area in the non volatile memory in advance to migrate the program before version upgrade, and consequently a large cost is required for the device.

In addition, in case of a low-cost device that includes only a minimum of a non volatile memory, an area to migrate the program before version upgrade can not be allocated in the non volatile memory in the aforementioned manner, and therefore it is difficult to apply the aforementioned method.

The present invention has been made in view of the aforementioned problem. It is an object of the present invention to achieve an electronic apparatus that enables to resume program update when powered on after stopping the program update due to power off, with a small area allocated for the program update in a non volatile memory.

### Solution to Problem

An electronic apparatus according to the present invention includes a processor that performs a process according to a program; and a non volatile memory that stores a target program to be updated and a boot program executed at starting up. The target program includes a rewriting program that rewrites the target program. The processor (a) downloads a update program used for update of the target program; (b) copies the rewriting program into the non volatile memory in accordance with the target program; (c) after copying the rewriting program, changes a program started by the boot program from the target program to the copied rewriting program, and reboots; (d) after the reboot, starts execution of the copied rewriting program in accordance with the boot program; and (e) rewrites the target program in the non volatile memory using the update program in accordance with the copied rewriting program.

### Advantageous Effect of Invention

According to the present invention, achieved is an electronic apparatus that enables to resume program update when powered on after stopping the program update due to power off, with a small area allocated for the program update in a non volatile memory.

### BRIEF DESCRIPTION OF DRAWINGS

FIG. 1 shows a block diagram that indicates a configuration of an electronic apparatus according to an embodiment of the present invention;

FIG. 2 shows a flowchart that explains a behavior for program update of the electronic apparatus shown in FIG. 1;

FIG. 3 shows a flowchart that explains a storage-using update process (Step S5) in FIG. 2;

FIG. 4 shows a block diagram that explains a data flow in the storage-using update process (Step S5) in FIG. 2;

FIG. 5 shows a flowchart that explains a storageless update process (Step S6) in FIG. 2; and

FIG. 6 shows a block diagram that explains a data flow in the storageless update process (Step S6) in FIG. 2.

### DESCRIPTION OF EMBODIMENTS

Hereinafter, an embodiment of the present invention will be explained with reference to drawings.

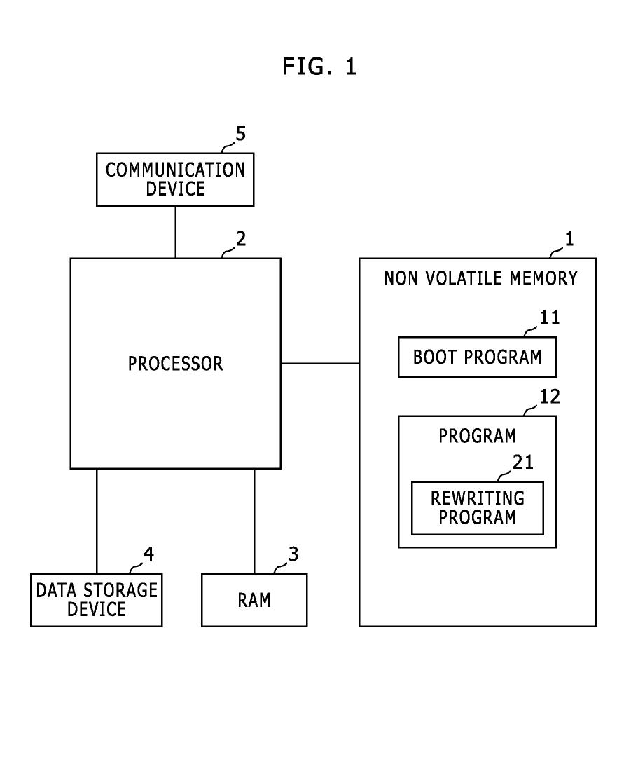

FIG. 1 shows a block diagram that indicates a configuration of an electronic apparatus according to an embodiment of the present invention. The electronic apparatus shown in FIG. 1 is an embedded system such as a multi function peripheral and is a sort of an electronic apparatus.

The electronic apparatus shown in FIG. 1 includes a non volatile memory 1 such as a flash memory, a processor 2 such as a CPU (Central Processing Unit), a RAM (Random Access Memory) 3 as a sort of a volatile memory, a data storage device 4 such as a hard disk drive or an SSD (Solid State Drive), and a communication device 5 such as a network interface.

The non volatile memory 1 stores a boot program 11 and a target program 12 to be updated (hereinafter, simply called “program 12”). The boot program 11 is a program firstly executed at starting up this electronic apparatus, and invokes another program and thereby starts execution of the invoked program. The program 12 is, such as a firmware, a program that performs controlling an unshown internal device in this electronic apparatus, and sorts of data processing, and is stored in a predetermined memory area of the non volatile memory 1. The program 12 includes a rewriting program 21 that rewrites the program 12. In general, the boot program 11 invokes a program stored in the predetermined memory area.

In accordance with a program stored in the non volatile memory 1, the processor 2 performs a process described in the program.

The processor 2 (a) downloads a update program used for update of the program 12 using the communication device 5; (b) copies the rewriting program 21 included in the program 12 into another area in the non volatile memory 1 in accordance with the program 12 (i.e. copies only the rewriting program 21 as a part of the program 12 rather than the whole of the program 12); (c) after copying the rewriting program 21, changes a program started by the boot program 11 from the program 12 to the copied rewriting program, and reboots; (d) after the reboot, in accordance with the boot program 11, starts execution of the copied rewriting program; and (e) in accordance with the copied rewriting program, rewrites the program 12 in the non volatile memory 1 using the update program.

Further, after rewriting the program 12 in the non volatile memory 1, in accordance with the copied rewriting program, the processor 2 changes a program started by the boot program from the copied rewriting program to the program 12 updated by using the update program, and reboots.

The communication device 5 performs data communication with a server or the like on an unshown network. The communication device 5 is used for downloading the aforementioned update program, and the like.

The following part explains a behavior of the aforementioned electronic apparatus.

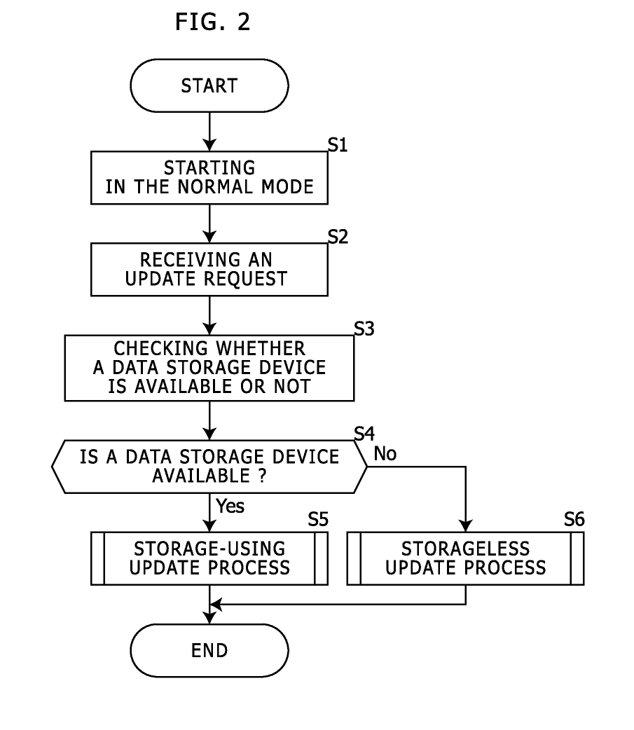

FIG. 2 shows a flowchart that explains a behavior for program update of the electronic apparatus shown in FIG. 1.

The processor 2 executes the boot program 11 at starting up. Subsequently, in a normal mode, in accordance with the boot program 11, the processor 2 starts execution of the program 12 (in Step S1).

Subsequently, while executing the program 12, if the processor 2 receives an update request of the program 12, then the processor 2 starts an update process (in Step S2). This update request is received, for example, through the network by the communication device 5.

In the update process, firstly the processor 2 searches a data storage device capable of storing an update program corresponding to the program 12 (in Step S3), and determines whether a data storage device capable of storing the update program is available other than the non volatile memory 1 or not (in Step S4). It should be noted that the update program corresponding to the program 12 is specified by the update request or determined by inquiry to a predetermined server.

If no data storage devices such as the data storage device 4 are available or if a data storage device such as the data storage device 4 is available but can not store the update program due to a small residual capacity, then it is determined that a data storage device capable of storing the update program is not available other than the non volatile memory 1.

Contrarily, if a data storage device such as the data storage device 4 is available and its residual capacity is sufficient for storing the update program, then it is determined that a data storage device capable of storing the update program is available other than the non volatile memory 1.

It should be noted that here the size of the update program is informed by the update request or determined by inquiry to a server from which the update program is downloaded, and the size and the residual capacity of the data storage device are compared with each other.

Subsequently, if such a data storage device is available other than the non volatile memory 1, then the processor 2 performs a storage-using update process (i.e. an update process in the first mode) (in Step S5). Contrarily, if such a data storage device is not available other than the non volatile memory 1, then the processor 2 performs a storageless update process (i.e. an update process in the second mode) (in Step S6).

Here explained is the storage-using update process (Step S5).

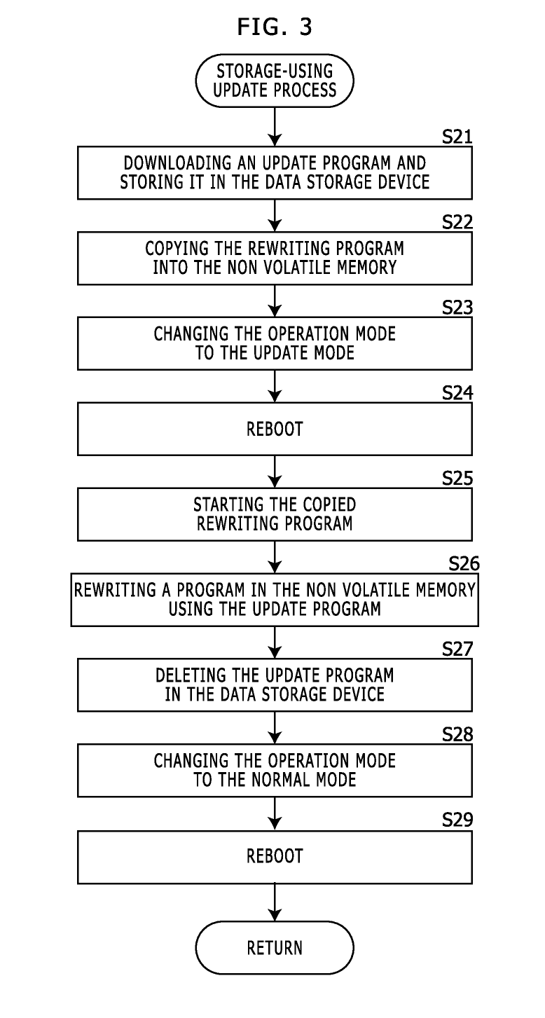

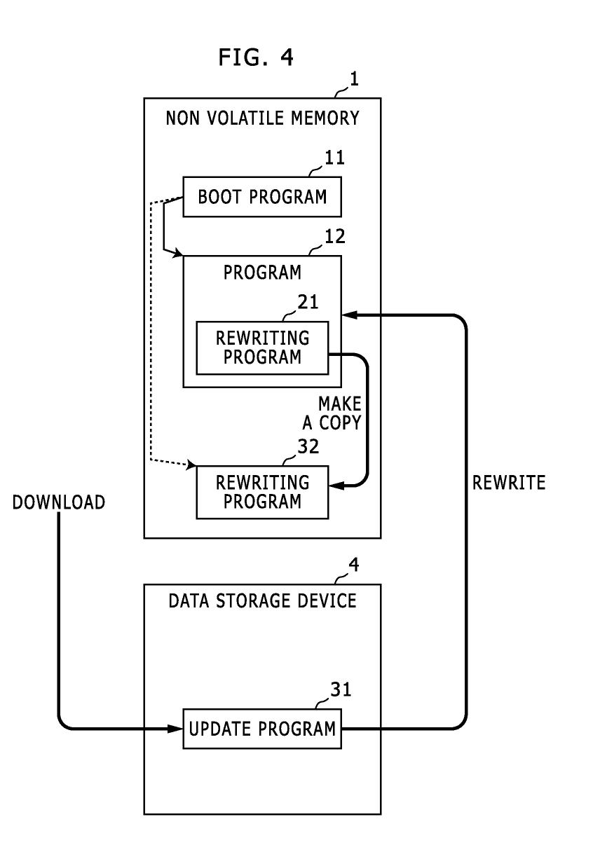

FIG. 3 shows a flowchart that explains a storage-using update process (Step S5) in FIG. 2. FIG. 4 shows a block diagram that explains a data flow in the storage-using update process (Step S5) in FIG. 2. Here the data storage device 4 is used for storing the update program 31.

In the storage-using update process, firstly in accordance with the program 12, the processor 2 downloads the update program 31 using the communication device 5, and stores the update program 31 into the data storage device 4 (in Step S21).

Subsequently, in accordance with the program 12, the processor 2 copies the rewriting program 21 into another area in the non volatile memory 1 (in Step S22).

Subsequently, after copying the rewriting program 21, the processor 2 changes a program started by the boot program 11, from the program 12 to the copied rewriting program 32 (in Step S23), and subsequently reboots (in Step S24). In other words, the processor 2 changes an operation mode from a normal mode to an update mode, and reboots; and in the normal mode the program 12 is started by the boot program 11, but in the update mode the rewriting program 32 is started by the boot program 11.

Due to this reboot, firstly the boot program 11 is executed. Subsequently in accordance with the boot program 11, the processor 2 starts execution of the copied rewriting program 32 (in Step S25).

Subsequently in accordance with the copied rewriting program 32, the processor 2 reads the update program 31 from the data storage device 4, and rewrites the program 12 by writing the update program over the program 12 in the non volatile memory 1 (in Step S26).

When finishing the rewriting of the program 12, in accordance with the copied rewriting program 32 the processor 2 deletes the update program 31 stored in the data storage device 4 (in Step S27).

Subsequently, the processor 2 changes a program started by the boot program 11, from the copied rewriting program 32 to the program 12 (i.e. the rewritten program 12) (in Step S28), and subsequently reboots (in Step S29). In other words, the processor 2 changes the operation mode from the update mode back to the normal mode, and reboots.

Consequently, after the reboot in Step S29, execution of the updated program 12 is started by the boot program 11.

In case of the storage-using update process, if power off occurs at a time before finishing Step S23, then the update process is performed again from Step S1, and if power off occurs at a time after finishing Step S23, then the update process is performed again from Step S25. Therefore, power off does not cause it to fall into an inoperative state.

Here explained is the storageless update process (Step S6).

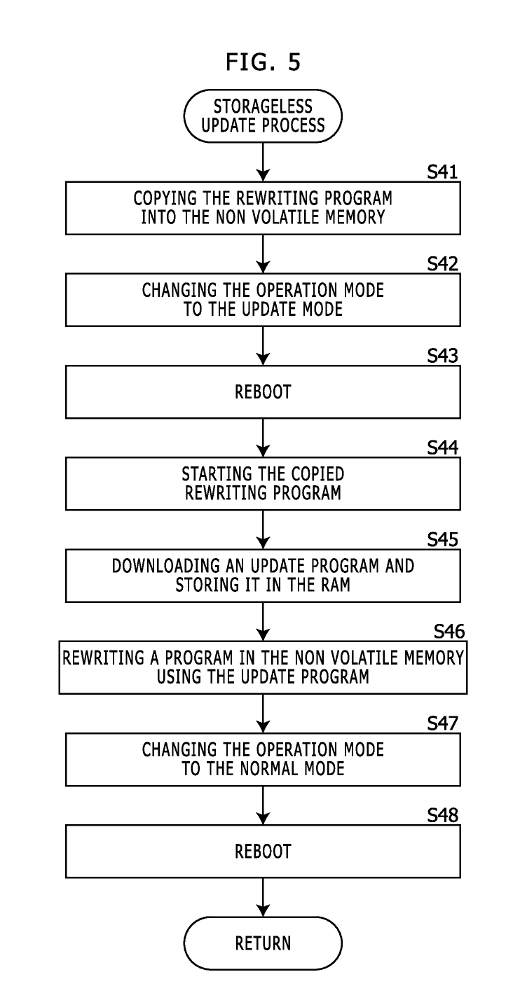

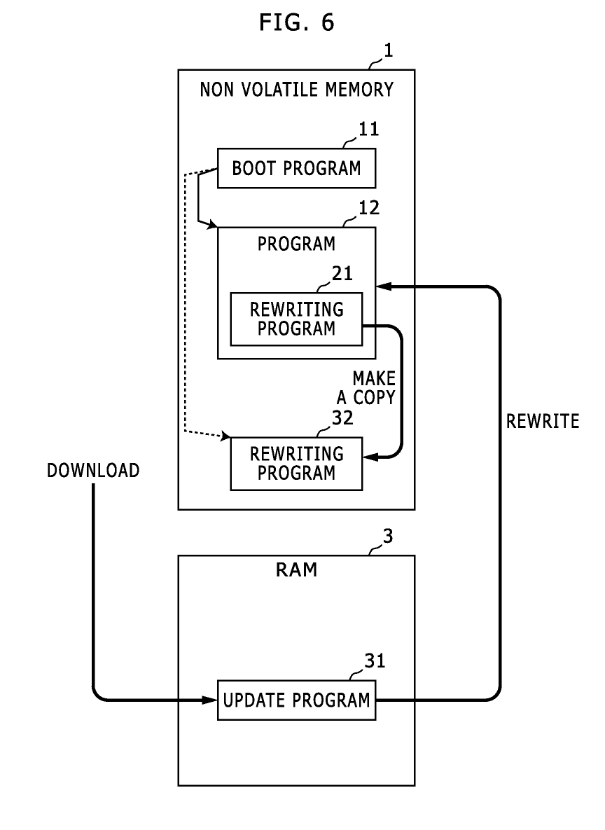

FIG. 5 shows a flowchart that explains a storageless update process (Step S6) in FIG. 2. FIG. 6 shows a block diagram that explains a data flow in the storageless update process (Step S6) in FIG. 2.

In the storageless update process, firstly in accordance with the program 12, the processor 2 copies the rewriting program 21 into another area in the non volatile memory 1 (in Step S41).

After copying the rewriting program 21, the processor 2 changes a program started by the boot program 11, from the program 12 to the copied rewriting program 32 (in Step S42), and subsequently reboots (in Step S43). In other words, the processor 2 changes the operation mode from the normal mode to the update mode, and reboots.

Due to this reboot, firstly the boot program 11 is executed. Subsequently, in accordance with the boot program 11, the processor 2 starts execution of the copied rewriting program 32 (in Step S44).

Subsequently, in accordance with the copied rewriting program 32, the processor 2 downloads the update program 31 using the communication device 5 and stores the update program 31 into the RAM 3 (in Step S45).

Further, in accordance with the copied rewriting program 32, the processor 2 reads the update program 31 from the RAM 3, and rewrites the program 12 by writing the update program over the program 12 in the non volatile memory 1 (in Step S46).

Subsequently, the processor 2 changes a program started by the boot program 11, from the copied rewriting program 32 to the program 12 (i.e. the rewritten program 12) (in Step S47), and subsequently reboots (in Step S48). In other words, the processor 2 changes the operation mode from the update mode back to the normal mode, and reboots.

Consequently, after the reboot in Step S48, execution of the updated program 12 is started by the boot program 11.

In case of the storageless update process, if power off occurs at a time before finishing Step S42, then the update process is performed again from Step S1, and if power off occurs at a time after finishing Step S42, then the update process is performed again from Step S44. Therefore, power off does not cause it to fall into an inoperative state.

As mentioned, in the aforementioned embodiment, the processor 2 (a) downloads the update program 31 used for update of a program 12; (b) copies the rewriting program 21 included in the program 12 into the non volatile memory 1 in accordance with the program 12; (c) after copying the rewriting program 21, changes a program started by a boot program 11 from the program 12 to the copied rewriting program 32, and reboots; (d) after the reboot, in accordance with the boot program 11, starts execution of the copied rewriting program 32; and (e) in accordance with the copied rewriting program 32, rewrites the program 12 in the non volatile memory 1 using the update program 31.

Consequently, even if a small area is allocated in the non volatile memory 1 to be used for program update (i.e. if an area in which the rewriting program 32 is written is allocated), the program update can be resumed when powered on after stopping the program update due to power off.

It should be noted that the aforementioned description has been presented for purposes of illustration and description, and is not intended to be exhaustive nor to limit the present invention.

For example, if in advance (for example, in manufacturing) it is known whether a data storage device capable of storing the update program 31 is available or not, then the processes of Steps S3 and S4 may be omitted and only one of the storage-using update process (Step S5) and the storageless update process (Step S6) may be performed.

Further, in the aforementioned embodiment, the processor 2 may store data that indicates which one of the storage-using update process (Step S5) and the storageless update process (Step S6) was selected into the non volatile memory 1, the RAM 3 or the like, and in accordance with the rewriting program 32, the processor 2 may refer to the data and thereby determine which one of the storage-using update process (Step S5) and the storageless update process (Step S6) is currently selected, and may perform a process to be performed in the determined update process. Alternatively, in accordance with the boot program 11, the processor 2 may provide the data as an argument to the rewriting program 32 when invoking the rewriting program 32. Alternatively, different rewriting programs 21 or 32 may be used respectively for the storage-using update process (Step S5) and the storageless update process (Step S6).

Further, it should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

### INDUSTRIAL APPLICABILITY

For example, the present invention is applicable to update of a program in an embedded system.

1. An electronic apparatus, comprising:
a processor that performs a process according to a program; and
a non volatile memory that stores a target program to be updated and a boot program executed at starting up;
a volatile memory;
wherein the target program includes a rewriting program that rewrites the target program; and the processor (a) downloads a update program used for update of the target program; (b) copies the rewriting program into the non volatile memory in accordance with the target program; (c) after copying the rewriting program, changes a program started by the boot program from the target program to the copied rewriting program, and reboots; (d) after the reboot, starts execution of the copied rewriting program in accordance with the boot program;
and (e) rewrites the target program in the non volatile memory using the update program in accordance with the copied rewriting program;
wherein the processor determines whether a data storage device capable of storing the update program is available other than the non volatile memory or not; if a data storage device capable of storing the update program is available other than the non volatile memory, the processor updates the target program in a first mode; and if a data storage device capable of storing the update program is not available other than the non volatile memory, the processor updates the target program in a second mode;
wherein in the first mode, before the reboot, in accordance with the target program, the processor downloads the update program and stores the update program into the data storage device, and after the reboot, in accordance with the copied rewriting program, the processor reads the update program from the data storage device and rewrites the target program in the non volatile memory using the read update program; and
in the second mode, after the reboot, in accordance with the copied rewriting program, the processor downloads the update program and stores the update program into the volatile memory, reads the update program from the volatile memory, and rewrites the target program in the non volatile memory using the read update program.

2-3. (canceled)

4. An electronic apparatus, comprising:
a processor that performs a process according to a program; and
a non volatile memory that stores a target program to be updated and a boot program executed at starting up;
a volatile memory;
wherein the target program includes a rewriting program that rewrites the target program; and
the processor (a) downloads a update program used for update of the target program; (b) copies the rewriting program into the non volatile memory in accordance with the target program; (c) after copying the rewriting program, changes a program started by the boot program from the target program to the copied rewriting program, and reboots; (d) after the reboot, starts execution of the copied rewriting program in accordance with the boot program; and (e) rewrites the target program in the non volatile memory using the update program in accordance with the copied rewriting program;
wherein if a data storage device capable of storing the update program is not available other than the non volatile memory, after the reboot, in accordance with the copied rewriting program, the processor downloads the update program and stores the update program into the volatile memory, reads the update program from the volatile memory, and rewrites the target program in the non volatile memory using the read update program.

5. The electronic apparatus according to claim 1, wherein after rewriting the target program in the non volatile memory using the update program, in accordance with the copied rewriting program, the processor changes a program started by the boot program from the copied rewriting program to the target program updated by using the update program, and reboots. 6 (new) The electronic apparatus according to claim 4, wherein if a data storage device capable of storing the update program is available other than the non volatile memory, before the reboot, in accordance with the target program, the processor downloads the update program and stores the update program into the data storage device, and after the reboot, in accordance with the copied rewriting program, the processor reads the update program from the data storage device and rewrites the target program in the non volatile memory using the read update program.
